(19) United States
(12) Patent Application Publication
(10) Pub. No.: US 2019/0155324 A1
(43) Pub. Date: May 23, 2019

(54) Timing Assembly and Toaster Oven

(71) Applicant: Elec-Tech International Co., Ltd., Zhuhai City, Guangdong (CN)

(72) Inventors: Donglei WANG, Guangdong (CN); Hengjie YANG, Zhuhai City, Guangdong (CN); Tuo WANG, Zhuhai City, Guangdong (CN); Peirun LIU, Zhuhai City, Guangdong (CN)

(21) Appl. No.: 16/300,350

(22) PCT Filed: Aug. 29, 2016
(86) PCT No.: PCT/CN2016/097202

§ 371 Date: Nov. 9, 2018

(30) Foreign Application Priority Data
May 10, 2016 (CN) 201620421870.0

(51) Int. Cl. G05G 1/10; A47J 37/06; H01H 19/14; F24C 7/08

(52) U.S. Cl. CPC G05G 1/10; F24C 7/085; H01H 19/14; A47J 37/06

(57) ABSTRACT

Disclosed are a timing assembly and a toaster oven, the timing assembly (100) including: a mounting panel (120); a knob assembly (110) including a knob portion (112) and a knob shaft (114), the knob portion (112) having a first state and a second state, the knob shaft (114) being connected to the knob portion (112); a timer (130); and a limiting member (140) fixedly connected to the mounting panel (120) and matched with the knob portion (112). When the knob portion (112) in the first state is rotated, the limiting member (140) limits the rotation of the knob portion (112) within a preset range, and when the knob portion (112) in the second state is rotated, the knob portion (112) avoids the limiting member (140). The a toaster oven includes the timing assembly (100).

### CROSS REFERENCE TO RELATED APPLICATIONS

This application is a continuation under 35 U.S.C. § 120 of international patent application PCT/CN2016/097202 filed on Aug. 29, 2016, which claims priority to Chinese patent application No. 201620421870.0, filed on May 10, 2016, entitled “TIMING ASSEMBLY AND TOASTER OVEN”, and the entire contents of which are incorporated herein by reference.

### TECHNICAL FIELD

The disclosure relates to the technical field of applications of the timer, in particular to a timing assembly and a toaster oven having same.

### BACKGROUND

Typically, for a timer used on an apparatus, a knob of the timer is rotated in a first direction (such as in a clockwise direction) to set the time of the timer. After finishing setting, the apparatus starts to work, and the knob of the timer rotates back automatically in a second direction (usually in a counterclockwise direction). When working time of the apparatus reaches the set time of the timer, the apparatus and the timer stop working at the same time, and the knob will automatically return to the “OFF” position.

However, for some timers, since an acceptable maximum set time is relatively short, while needed working time of the apparatus is longer, in this case, the timer needs to have a stay-on function. The apparatus remains in a working state under the stay-on condition, and the timer also remains in a working state under the stay-on condition. In the case of the timer having such a structure, when the set working time of the timer exceeds the actual needed working time of the apparatus, the user needs to manually reset the timer to zero to turn off the timer, so as to turn off the apparatus. The direction of rotating the timer from the working state to the zeroing state is the second direction, while the direction for choosing the stay-on condition is also the second direction, thus the user may turn the timer to the stay-on condition. In this case, the user may think that the apparatus is turned off but the apparatus is actually in the working state, which can cause safety risks.

### SUMMARY

In view of this, it is necessary to provide a timing assembly that has an improved safety to solve the above problem.

On one aspect of the present disclosure, a timing assembly is provided, including:

a mounting panel;

a knob assembly, including a knob portion and a knob shaft, the knob portion being located at one side of the mounting panel, the knob potion being rotatable relative to the mounting panel, and the knob potion having a first state and a second state, and the knob shaft being connected to the knob portion;

a timer, including a body and a first connecting shaft, the body being located at another side of the mounting panel, and the body being fixedly connected to the mounting panel, and the first connecting shaft being disposed on the body, and the first connecting shaft and the knob shaft being fixedly connected; and

a limiting member, fixedly connected to the mounting panel, the limiting member matched with the knob portion; when the knob portion in the first state is rotated, the limiting member being capable of limiting the rotation of the knob portion within a preset range, and when the knob portion in the second state is rotated, the knob portion being capable of avoiding the limiting member.

In one embodiment, the knob assembly further includes an elastic component and a fastener, and the knob shaft is elastically connected to the knob portion by the elastic component, and the fastener is connected to the elastic component.

In one embodiment, the knob portion includes a connection column and a barrel portion, and the connection column is disposed at the barrel portion, and the connection column is elastically connected to the knob shaft by the elastic component.

In one embodiment, the knob shaft includes a clamping portion and a second connecting shaft, and the second connecting shaft is fixedly connected to the clamping portion, and the clamping portion is elastically connected to the knob portion by the elastic component.

In one embodiment, the knob portion includes the connection column and the barrel portion, and the connection column is disposed at the barrel portion, and the connection column is elastically connected to the clamping portion by the elastic component.

In one embodiment, at least one latching member is disposed on the barrel portion, and the latching member is engaged with the clamping portion.

In one embodiment, at least one clamping slot is disposed on the clamping portion, and the latching member is engaged in the clamping slot.

In one embodiment, there are four latching members uniformly disposed along the circumferential direction of the barrel portion, and the latching member mates with the limiting member; when the knob portion in the first state is rotated, the limiting member limits the rotation of the latching member within the preset range, and when the knob portion in the second state is rotated, the latching member is capable of avoiding the limiting member.

In one embodiment, the elastic component is in an uncompressed state when the knob portion is in the first state; and the elastic component is in a compressed state when the knob portion is in the second state.

On another aspect, the present disclosure provides a toaster oven including a toaster oven body and a timing assembly according to any of the embodiments, wherein the timing assembly is disposed on the toaster oven body.

Advantages and beneficial effects of the present disclosure are as follows: according to the timing assembly of the present disclosure, since the timing assembly is provided with a limiting member fixedly connected to the mounting panel, and the limiting member is matched with the knob portion, when the knob portion in the first state is rotated, the limiting member is capable of limiting the rotation of the knob portion within a preset range, and when the knob portion in the second state is rotated, the knob portion is capable of avoiding the limiting member. By altering the knob portion to the first state or the second state, it is convenient to adjust the timer assembly. When the knob portion is in the first state, the timer can be automatically turned off after reaching a preset time, which can prevent the timer from switching to a stay-on mode caused by a failure of the timer or due to other reasons, thereby preventing the apparatus from being in the working state all the time and resulting in potential safety risks. And when the knob portion in the second state is rotated, the knob portion can avoid the limiting member. When a user wants to use the timing assembly under the stay-on mode, the user only needs to make the movable assembly to be in the second state, and the knob assembly can be passed over the limiting member and switched to the stay-on mode. The disclosure has a simple structure and is able to avoid potential safety risks.

### BRIEF DESCRIPTION OF DRAWINGS

In order to illustrate the embodiments of the present disclosure or the technical solutions in the prior art more clearly, the drawings to be used in the embodiments or the prior art will be briefly described below. Obviously, the drawings in the following description are only some embodiments of the present disclosure, and those skilled in the art can obtain other drawings according to these drawings without any creative work.

FIG. 1 is a structural diagram of a timing assembly in accordance with one embodiment of the disclosure;

FIG. 2 is a structural diagram of a knob assembly of the timing assembly shown in FIG. 1;

FIG. 3 is an assembly diagram of the knob assembly of the timing assembly shown in FIG. 2;

FIG. 4 is a partial schematic view of a mounting panel of the timing assembly shown in FIG. 1;

FIG. 5 is a sectional view of the timing assembly in a first state shown in FIG. 1 in accordance with one embodiment of the disclosure;

FIG. 6 is a sectional view of the timing assembly in a second state shown in FIG. 1 in accordance with one embodiment of the disclosure;

FIG. 7 is a diagram illustrating a working scene for the timing assembly shown in FIG. 1 in accordance with one embodiment;

FIG. 8 is a structural diagram of a toaster oven in accordance with one embodiment;

In the drawings: knob assembly 110, knob portion 112, connection column 112a, barrel portion 112b, latching member 112c, knob shaft 114, clamping portion 114a, second connecting shaft 114b, clamping slot 114c, elastic component 116, fastener 118, mounting panel 120, limiting member 140, timer 130, body 132, first connecting shaft 134, toaster oven body 200, timing assembly 100.

### DETAILED DESCRIPTION OF PREFERRED EMBODIMENTS

The present disclosure will be described in more details below with reference to relevant drawings and embodiments. It should be understood that the embodiments described herein are merely used for explaining technical solutions of the present disclosure, rather than for limiting the scope of the present disclosure.

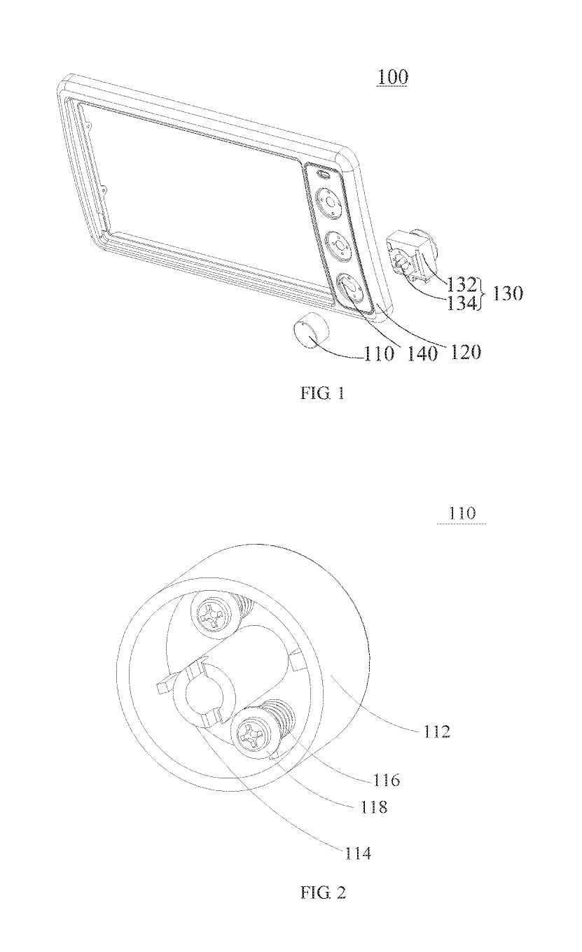

Referring to FIG. 1 and FIG. 2, the timing assembly 100 of the embodiment includes a mounting panel 120 and a knob assembly 110. The knob portion 110 includes a knob portion 112 and a knob shaft 114. Wherein, the knob portion 112 is located at one side of the mounting panel 120, and the knob portion 112 is rotatable relative to the mounting panel 120, wherein the knob portion 112 is capable of rotating not only in a first direction (usually in a clockwise direction) but also in a second direction (usually in a counterclockwise direction). And the knob shaft 114 is connected to the knob portion 112 and capable of rotating with the knob portion 112, wherein the knob shaft 114 is capable of rotating not only in a first direction (usually in a clockwise direction) but also in a second direction (usually in a counterclockwise direction). Wherein the knob portion 112 has two states, the first state and the second state, respectively.

The timing assembly 100 further includes a timer 130, and the timer 130 can have a mechanical timing structure. The timer 130 includes a body 132 and a shaft 134. Wherein, the body 132 is located at another side of the mounting panel 120 and is fixedly connected to the mounting panel 120. Wherein, the body 132 can be connected to the mounting panel 200 by bolts or screws; the first connecting shaft 134 is disposed on the body 132, and the first connecting shaft 134 is fixedly coupled to the knob portion 112.

The timing assembly 100 further includes a limiting member 140, and the limiting member 140 is fixedly connected to the mounting panel 120, and the limiting member 140 is matched with the knob portion 112, wherein the “match” may mean that at least a part of the knob portion 112 is matched with the limiting member 140, so that the knob portion 112 in the first state cannot be rotated freely, that is, when the knob portion 112 in the first state is rotated, the limiting member 140 can limit the rotation of the knob portion 112 within a preset range. When the knob portion 112 in the second state is rotated, the knob portion 112 can avoid the limiting member 140. In this embodiment, the limiting member 140 can be a baffle, certainly, the limiting member having other structures that serve the same function can also be used.

It should be noted that, when the knob portion 112 is in the first state, the timing assembly 100 is in a mode when choosing a timing mode, and when the knob portion 112 is in the second state, the timing assembly 100 is in a mode when choosing a stay-on mode. Wherein, the timing mode is a mode when the timing assembly is used for presetting time. That is, the timing assembly 100 can acquire a preset time set by the user, and the preset time is corresponding to the rotation of the knob portion 112 within a preset range, and the stay-on mode refers to a mode that the timing assembly 100 is in a working state all the time.

When the timing assembly 100 of the embodiment is in use, when the knob portion 112 is in the first state, the timing assembly is in the timing mode, and the knob portion 112 is rotated in the first direction (usually in the clockwise direction) to preset the timekeeping time of the timer 130, then the timer 130 starts to work. After the preset time is reached, the timer 130 can be automatically turned off. In addition, when the timer 130 has a non-human failure, for example, if the timer 130 does not stop working after the preset time is reached, then the limiting member of the timing assembly 100 can prevent the timer 130 from jumping to the stay-on mode, and prevent the machine from working all the time, so as to avoid safety risks. In addition, the preset time for the timer 130 set by the user may be too long and exceed the actual needed time, for example, the needed time is 30 minutes but the user has set the time as 45 minutes or even more, in this case, the user may need to perform a zeroing operation on the timer 130 initiatively, and need to rotate the knob portion 112 in the second direction (usually counterclockwise). Since the direction of rotating the timer 130 from the working state to the OFF position is consistent with the direction for choosing the stay-on mode, it is possible that the timer 130 is always working while the user thought that the timer 130 was turned off, which will incur safety risks. In this case, the limiting member provided can prevent the above two events from occurring, and the safety is greatly improved. When it is necessary to choose the stay-on mode, the knob portion 112 is changed to the second state, when the knob portion 112 in the second state is rotated, the knob portion is able to avoid the limiting member, and it is convenience for the user to choose the timer 130 in the stay-on mode. The embodiment has a simple structure and can prevent safety risks.

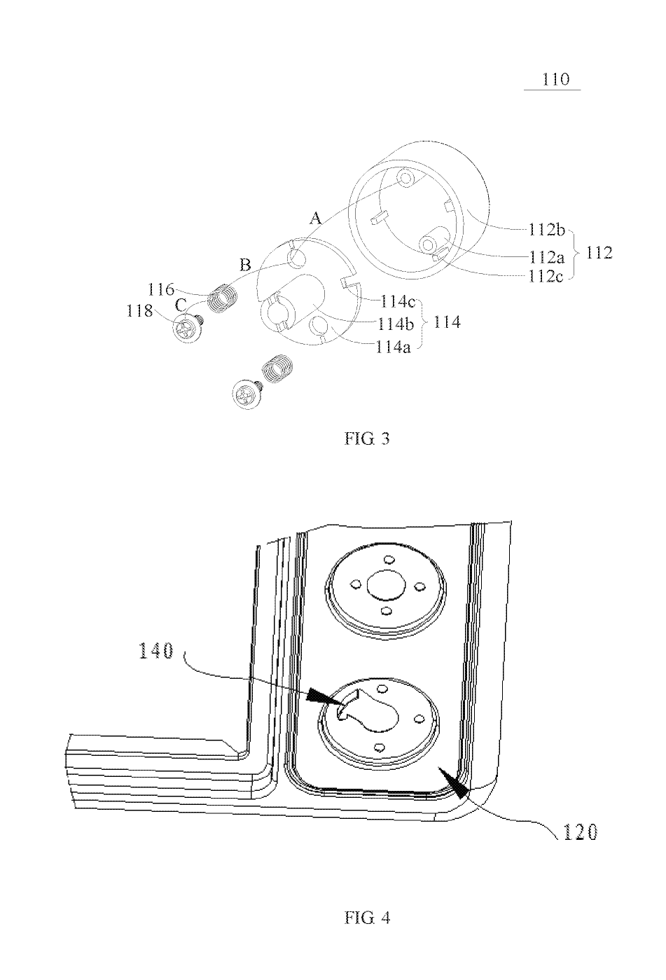

Further referring to FIG. 2 and FIG. 3, FIG. 2 is a structural diagram of a knob assembly of the timing assembly shown in FIG. 1; FIG. 3 is an assembly diagram of the knob assembly of the timing assembly shown in FIG. 2. As shown in FIG. 2 and FIG. 3, the knob assembly 110 may further include an elastic component 116 through which the knob shaft 114 may be elastically connected to the knob portion 112. Wherein, the elastic component 116 may be a spring. Of course, other elastic components having the same function of generating elasticity are also acceptable. In order to fix the spring, the knob assembly 110 may further include a fastener 118 coupled to the spring, so that the spring may be fixed to the knob portion 112. The fastener 118 may be a screw, and other fasteners 118 having the same function are also acceptable. Wherein, the use of spring and screw can make the structure of the time assembly 100 more simple and compact.

The knob shaft 114 may further include a clamping portion 114a and a second connecting shaft 114b. The second connecting shaft 114b is fixedly connected to the clamping portion 114a, and the clamping portion 114a is elastically connected to the knob portion 112 through the spring.

The knob portion 112 may further include a connection column 112a and a barrel portion 112b, the connection column 112a may be cylindrical and fixedly disposed on the barrel portion 112b, and the connecting column 112a may rotate together with the barrel portion 112b. Correspondingly, a through hole engaged with the connecting column 112a is disposed on the clamping portion 114a at a position corresponding to the connecting column 112a. As such, the spring penetrates through the through hole on the clamping portion to elastically connect with the connecting column 112a, and the spring is fixed to the connecting column 112a by the screw.

The barrel 112b is further provided with at least one latching member 112c. In the embodiment, preferably, four latching members 112c may be provided uniformly along the circumferential direction of the barrel portion 112b, certainly, other number of latching members 112c may be provided. In the embodiment, the latching member 112c is not limited to be uniformly disposed along the circumferential direction of barrel portion 112b, as long as the function of clamping is satisfied and the knob portion 112 in the first state rotating within the preset range can be ensured. The latching member 112c clamps with the clamping portion 114a, and the latching member 112c matched with the baffle. When the knob portion 112 in the first state is rotated, the baffle can limit the latching member 112c to be rotated within the preset range. In the embodiment, the preset range in the present disclosure refers to that, when the timing assembly 100 is in the timing mode, the knob portion 112 is rotated to obtain the timekeeping time required by the corresponding machine. When the knob portion 112 in the second state is rotated, the latching member 112c can avoid the baffle.

In order to better engage with the latching member 112c, at least one clamping slot 114c may be defined on the latching portion 114a. The clamping slot 114c is adapted to the latching member 112c, and the latching member 112c is latched into the clamping slot 114c. The number of the clamping slots 114c and which arrangement are separately along the peripheral direction of the clamping portion 114a are corresponding to the latching members 112c. The number of the clamping slots 114c in this embodiment is not limited thereto, which number and arrangement along the clamping portion 114a only needs to correspond to the latching member 112c. In this embodiment, the knob shaft 114 is circumferentially fixed by engaging with the latching member 112c and the clamping slot 114c, so that the knob shaft 114 and the knob portion 112 are integrated, and the knob shaft 114 can only rotate together with the knob portion 112, and the structure is simple.

In the embodiment, the spring is in the non-compressed state when the knob portion 112 is in the first state; the spring is in the compressed state when the knob portion 112 is in the second state. More specifically, when the user needs to change the state of the knob portion 112 and expects the timing assembly 100 to be in the stay-on mode, since the knob portion 112 and the knob shaft 114 are elastically connected by the spring, and the second connecting shaft 114b is connected with the first connecting shaft 134, when the knob portion 112 is pulled outward, the spring is in the compressed state, and the knob portion 112 moves outward. As such, the latching member 112c can avoid the baffle, and the knob portion 112 can normally rotate to the stay-on mode. The embodiment has a simple structure, and it is convenience for switching the timing mode and it can prevent safety risks.

When assembling the knob assembly 110, as shown in FIG. 3. Step 1: as shown in FIG. A, the embodiment, firstly assembles the knob shaft 114 to the knob portion 112, and the latching member 112c is clamped with the clamping slot 114c to position the knob shaft 114 in the circumferential direction. In addition, the through hole defined on the clamping portion 114a is corresponding to the connecting column 112a. Step 2: referring to FIG. B, the spring is assembled into the through hole on the clamping portion 114a; Step 3: referring to FIG. C, the screw is assembled, the screw is assembled to the spring, and the spring is fixed to the connecting column 112a. The structure is simple and it is easy to assemble.

Further referring to FIG. 4, it is a partial schematic view of the mounting panel 120 of the timing assembly 100 shown in FIG. 1. As shown in the figure, a limiting member 140 is disposed on the mounting panel 120. The preferred limiting member 140 of the embodiment includes a baffle, and the baffle is disposed on the mounting panel 120 and protrudes out of the mounting panel 120. Of course, the limiting member 140 having other structures that serve the same function can also be used.

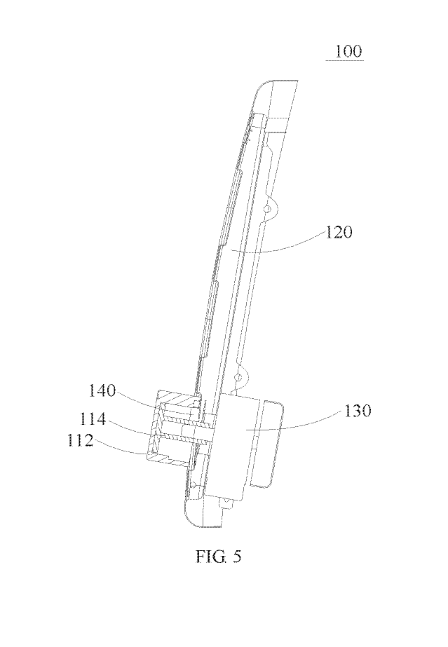

Further referring to FIG. 5, it is a sectional view of the timing assembly 100 in the first state in one embodiment. In FIG. 5, after the preset time for the timing assembly 100 is reached, the baffle can prevent the latching member 112c from passing over the baffle, further prevent the knob portion 112 from continuing rotating, so that the timer 130 can stop timing immediately, and correspondingly the apparatus can stop working.

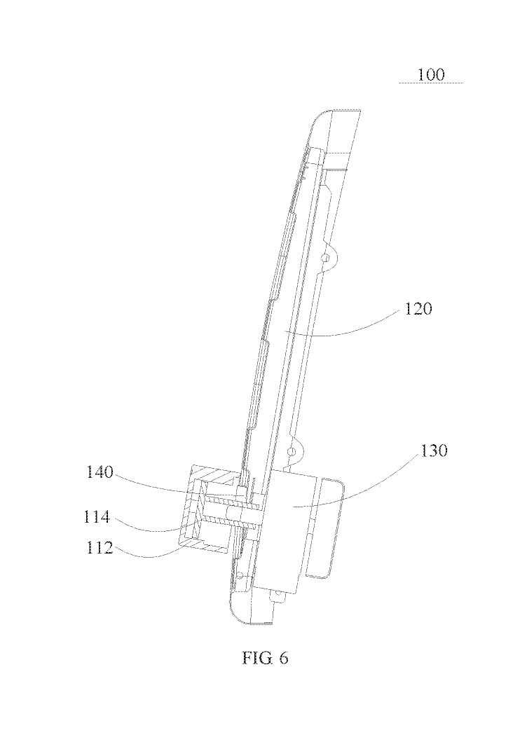

Further referring to FIG. 6, it is a sectional view of the timing assembly 100 in the second state in one embodiment. As shown in FIG. 6, when the timing assembly 100 needs to work in the second state, it is simply needed to pull outward the knob portion 112, then the spring is compressed, and since the knob portion 112 moves outward, the latching member 112c disposed inside the knob portion can avoid the baffle, and the knob portion 112 can rotate normally.

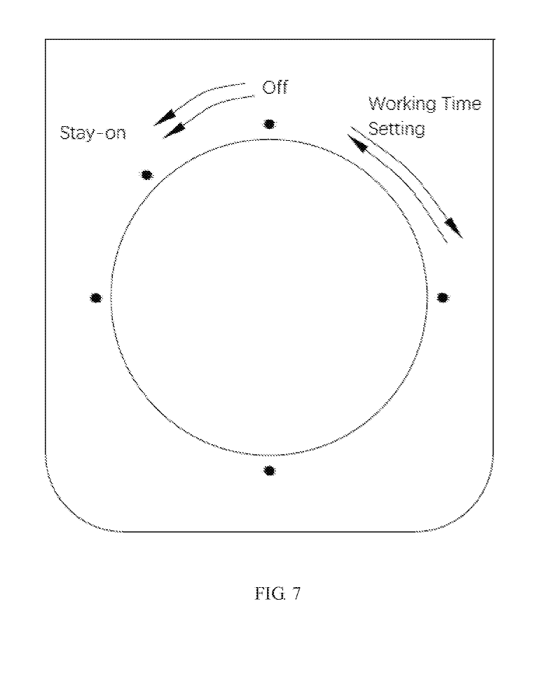

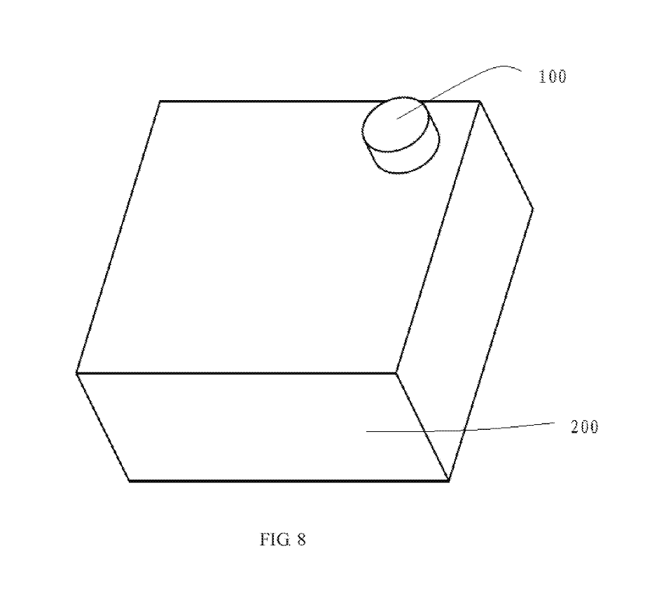

Further referring to FIG. 7, it is a diagram illustrating a working scene for the timing assembly 100 in accordance with one embodiment. As shown in FIG. 7, the timing assembly 100 has two states, when the timing assembly is in the timing mode, the timekeeping time of the timer 130 is preset by rotating in the clockwise direction, when the actual working time is less than the preset time, the user may need to perform a zeroing operation manually, which direction of rotation is counter-clockwise. Since the direction for choosing the stay-on mode is consistent with the direction for zeroing operation, that is counter-clockwise, the direction for both is the same, which will incur safety risks. The baffle and the knob portion 112 arranged according to the present disclosure can be conveniently used for choosing the two modes by switching the states of the knob portion 112, and can avoid the above-mentioned safety risks as well.

The working principle of the disclosure will be further described below:

When the user uses the timing assembly 100 in the timing mode, and manually turns off the timer 130 in the working state, the baffle can block the knob portion 112 from rotating towards the stay-on mode as long as the timer 130 reaches an OFF position. Thereby the timer 300 is prevented from reaching the stay-on mode. When the user needs to use the timing assembly 100 in the stay-on mode, the user needs to pull outward the knob portion 112, then the spring 124 is compressed, and latching member 112c avoids the baffle 140, as shown in FIG. 6. Thereby, the knob portion 112 can rotate normally from the timing mode to the stay-on mode, without affecting the user's using the timing assembly 100 in the stay-on mode.

In addition, the apparatus can prevent the timer 130 from jumping to the stay-on mode to cause the machine to be working all the time when a failure occurs, avoiding the potential safety risks caused thereby.

Further referring to FIG. 8, it is a structural schematic diagram of a toaster oven, relating to a second aspect of the present disclosure. The toaster oven includes a toaster oven body 200 and the timing assembly 100 according to any of the above embodiments, wherein the timing assembly 100 is disposed on the toaster oven body 200. Referring to FIG. 2 together, when the toaster oven needs to be used in the timing mode, it is only needed to rotate the knob portion 112 on the timing assembly 100 in the clockwise direction, and when the knob portion 112 is rotated to a desired scale position, the knob portion 112 is released, then the electric contacts inside the timer 130 are connected, and the toaster oven starts to work. When the toaster oven needs to be used in the second state, the knob portion 112 in the timing assembly 100 can be changed to the second state, and the baffle can be avoided in this case. For a more specific structure of the timing assembly 100, references may be made to the timing assembly 100 described in the first aspect of the present disclosure, which are not repeated herein.

The technical features of the above-described embodiments can be arbitrarily combined. For simplicity, not all possible combinations of the technical features in the above embodiments are illustrated. However, the combinations shall fall into the scope of the present disclosure as long as there is no contradiction among the combinations of these technical features.

What described above are a plurality of embodiments of the present disclosure, they are relatively concrete and detailed, but not intended to limit the scope of the present disclosure. It will be understood by those skilled in the art that various modifications and improvements can be made without departing from the conception of the present disclosure, and all these modifications and improvements are within the scope of the present disclosure. The scope of the present disclosure shall be subject to the accompanied claims.

1. A timing assembly comprising:
a mounting panel;
a knob assembly, comprising a knob portion and a knob shaft, the knob portion being located at one side of the mounting panel, the knob portion being rotatable relative to the mounting panel, and the knob portion having a first state and a second state, and the knob shaft being connected to the knob portion;
a timer, comprising a body and a first connecting shaft, the body being located at another side of the mounting panel, and the body being fixedly connected to the mounting panel, and the first connecting shaft being disposed on the body, and the first connecting shaft and the knob shaft being fixedly connected; and
a limiting member, fixedly connected to the mounting panel, the limiting member matched with the knob portion; when the knob portion in the first state is rotated, the limiting member being capable of limiting the rotation of the knob portion within a preset range, and when the knob portion in the second state is rotated, the knob portion being capable of avoiding the limiting member.

2. The timing assembly according to claim 1, wherein the knob assembly further comprises an elastic component and a fastener, and the knob shaft is elastically connected to the knob portion by the elastic component, and the fastener is connected to the elastic component.

3. The timing assembly according to claim 2, wherein the knob portion comprises a connection column and a barrel portion, and the connection column is disposed at the barrel portion, and the connection column is elastically connected to the knob shaft by the elastic component.

4. The timing assembly according to claim 2, wherein the knob shaft comprises a clamping portion and a second connecting shaft, and the second connecting shaft is fixedly connected to the clamping portion, and the clamping portion is elastically connected to the knob portion by the elastic component.

5. The timing assembly according to claim 4, wherein the knob portion comprises the connection column and the barrel portion, and the connection column is disposed at the barrel portion, and the connection column is elastically connected to the clamping portion by the elastic component.

6. The timing assembly according to claim 5, wherein at least one latching member is disposed on the barrel portion, and the latching member is engaged with the clamping portion.

7. The timing assembly according to claim 6, wherein at least one clamping slot is disposed on the clamping portion, and the latching member is engaged in the clamping slot.

8. The timing assembly according to claim 7, wherein there are four latching members uniformly disposed along the circumferential direction of the barrel portion, and the latching member mates with the limiting member; when the knob portion in the first state is rotated, the limiting member limits the rotation of the latching member within the preset range, and when the knob portion in the second state is rotated, the latching member is capable of avoiding the limiting member.

9. The timing assembly according to claim 8, wherein the elastic component is in an uncompressed state when the knob portion is in the first state; and the elastic component is in a compressed state when the knob portion is in the second state.

10. A toaster oven comprising a toaster oven body and a timing assembly according to claim 1, wherein the timing assembly is disposed on the a toaster oven body.

11. The toaster oven according to claim 10, wherein the knob assembly further comprises an elastic component and a fastener, and the knob shaft is elastically connected to the knob portion by the elastic component, and the fastener is connected to the elastic component.

12. The toaster oven according to claim 11, wherein the knob portion comprises a connection column and a barrel portion, and the connection column is disposed at the barrel portion, and the connection column is elastically connected to the knob shaft by the elastic component.

13. The toaster oven according to claim 11, wherein the knob shaft comprises a clamping portion and a second connecting shaft, and the second connecting shaft is fixedly connected to the clamping portion, and the clamping portion is elastically connected to the knob portion by the elastic component.

14. The toaster oven according to claim 13, wherein the knob portion comprises the connection column and the barrel portion, and the connection column is disposed at the barrel portion, and the connection column is elastically connected to the clamping portion by the elastic component.

15. The toaster oven according to claim 14, wherein at least one latching member is disposed on the barrel portion, and the latching member is engaged with the clamping portion.

16. The toaster oven according to claim 15, wherein at least one clamping slot is disposed on the clamping portion, and the latching member is engaged in the clamping slot.

17. The toaster oven according to claim 16, wherein there are four latching members uniformly disposed along the circumferential direction of the barrel portion, and the latching member mates with the limiting member; when the knob portion in the first state is rotated, the limiting member limits the rotation of the latching member within the preset range, and when the knob portion in the second state is rotated, the latching member is capable of avoiding the limiting member.

18. The toaster oven according to claim 17, wherein the elastic component is in an uncompressed state when the knob portion is in the first state; and the elastic component is in a compressed state when the knob portion is in the second state.
